(19) United States
(12) Patent Application Publication
(10) Pub. No.: US 2010/0178010 A1
(43) Pub. Date: Jul. 15, 2010

(54) CONNECTION SYSTEM COMPRISING A CONNECTOR AND A RECEPTACLE

(75) Inventors: Christoph Werner, Bischoffen (DE); Jürgen Nehler, Bad Nauheim (DE)

Correspondence Address: RATNERPRESTIA, P.O. BOX 980, VALLEY FORGE, PA, 19482, US

(73) Assignee: EUROMICRON WERKZEUGE GmbH, Sinn-Fleisbach (DE)

(21) Appl. No.: 12/600,730

(22) PCT Filed: May 13, 2008
(86) PCT No.: PCT/EP08/03833

§ 371 Date: Mar. 25, 2010

(30) Foreign Application Priority Data
May 18, 2007 (DE) 10 2007 023 250.2

(51) Int. Cl. G02B 6/38

(52) U.S. Cl. 385/65

(57) ABSTRACT

A connection system including a connector and a receptacle through each of which an optical fiber is passed, wherein the connector includes a ferrule and also a cylindrical shoulder with a larger diameter than the ferrule on the side of the ferrule facing the fiber and the receptacle has a stepped bore for receiving the ferrule and the cylindrical shoulder, wherein the dimensions of the ferrule, of the cylindrical shoulder and of the stepped bore correspond to a standard FSMA connector or receptacle, wherein the connector has at least one groove and the receptacle at least one tongue corresponding thereto, wherein the tongue projects into the groove when the connector and receptacle are plugged together and wherein the groove is defined on the cylindrical shoulder and the tongue is defined on the bore.

### CROSS REFERENCE TO RELATED APPLICATIONS

This is a U.S. National Phase application of PCT application number PCT/EP2008/003833, filed May 13, 2008, which claims priority benefit of German application number DE 10 2007 023 250.2 (filed May 18, 2007), the content of such applications being incorporated herein by reference.

### FIELD OF THE INVENTION

The present invention relates to a connection system, a connector and a receptacle.

### BACKGROUND OF THE INVENTION

The FSMA (also SMA) connector (FSMA=field installable subminiature assembly) is one of the first optical fibre (OF) connectors to have been internationally standardized. It is standardized by the document IEC-SC 86B(CO)20. The FSMA connector is a screw connector in which the fibre is carried in a relatively long metal ferrule with a pin diameter of 3.175 mm which is surface-ground at the contact face.

The FSMA plug-in connection can be used for multimode fibres, graded-index profiled fibres and step-index profiled fibres. The optical fibre is permanently and reliably connected to the connector or the coupling by means of adhesive. The FSMA connector is available in two versions with a continuous cylindrical connector pin (version 905) and with a tapered connector pin for centering sleeves (version 906).

The connection between connector and receptacle has no protection against turning, which manifests itself negatively in the insertion loss, e.g. in the form of scratches and concomitant higher loss, upon repeated opening and closing due to the friction occurring at the end-faces of the optical fibres. Moreover, the connector can be affected at high response torques by bending of the fibre guide, which can likewise worsen its insertion loss.

Also, any connectors can be inserted into any receptacles, with the result that there is no distinction between different connection possibilities. WO2004/097988 discloses, as a solution to the last-named problem, a connector with a shoulder at the end-face of the ferrule. This can be introduced both into a receptacle according to version 905 or 906 and into a corresponding receptacle with a stepped bore corresponding to the shoulder. Conversely, a standard FSMA connector cannot be introduced into the receptacle according to WO2004/097988.

### SUMMARY OF THE INVENTION

An object of the present invention is therefore to provide a connection system compatible with the FSMA standard, in which the connector allows a connection with a standard FSMA receptacle, but a standard FSMA connector does not allow a connection with the receptacle belonging to the connection system, wherein the connector is secured against turning vis-à-vis the receptacle.

This problem is solved by a connection system comprising a connector and a receptacle through each of which an optical fibre is passed, wherein the connector comprises a ferrule and also a cylindrical shoulder with a larger diameter than the ferrule on the side of the ferrule facing the fibre and the receptacle has a stepped bore for receiving the ferrule and the cylindrical shoulder, wherein the dimensions of the ferrule, of the cylindrical shoulder with a larger diameter than the ferrule on the side of the ferrule facing the fibre and of the stepped bore correspond to a standard FSMA connector or receptacle, wherein the connector has at least one groove and the receptacle at least one tongue corresponding thereto, wherein the tongue projects into the groove when the connector and receptacle are plugged together and wherein the groove is introduced into the cylindrical shoulder with a larger diameter than the ferrule and the tongue into the bore, corresponding to this section, with the larger diameter of the stepped bore. By means of different connectors and receptacles each with corresponding projections and recesses, series can be created which allow specific combinations of connectors and receptacles and forbid other combinations. Thus hierarchies of allowed and forbidden connection possibilities can be converted into connector/receptacle combinations, wherein the connectors and receptacles differ only in the arrangement of the projections or recesses.

The groove and the tongue preferably extend in radial direction, whereby these can be radially worked into or out of the corresponding surface.

The groove and the tongue preferably have a rectangular cross-section at least over a part-length. This naturally has curves at the junctions between faces perpendicular to each other. Such a cross-section can be produced with customarily used milling cutters.

The end of the groove facing the fibre is preferably rounded, whereby a milling cutter with a diameter of the groove width can be used.

The tongue is preferably formed by a radially extending lug of the receptacle. The lug thus has a smaller axial length than the groove of the connector, which makes its manufacture easier.

Radially extending notches are preferably arranged on both sides of the lug. These allow the lug to be produced by a milling cutter introduced axially into the receptacle.

The connector and the receptacle preferably comprise means for the releasable axial fixing of union nuts, in particular one fitted over the connector, screwed onto an external thread of the receptacle.

The problem named at the outset is also solved by a connector with means of coupling electromagnetic radiation into a fibre for the transmission of the radiation, wherein the connector has a ferrule and a cylindrical shoulder with a larger diameter than the ferrule on the side of the ferrule facing the fibre, characterized in that the connector has a radially introduced groove.

The problem named at the outset is also solved by a receptacle with means of coupling electromagnetic radiation into a fibre for the transmission of the radiation, wherein this has a stepped bore for receiving a ferrule and a cylindrical shoulder of a connector, characterized in that the receptacle has a lug extending radially inwards.

### BRIEF DESCRIPTIONS OF DRAWINGS

An embodiment example of the present invention will be explained in more detail below with the help of the attached drawings. There are shown in:

FIG. 1 depicts a three-dimensional representation of an embodiment example of a connector according aspects of the invention;

FIG. 2 depicts the connector according to FIG. 1 in side view;

FIG. 3 depicts the connector according to FIGS. 1 and 2 in front view;

FIG. 4 depicts an embodiment example of a receptacle according to aspects of the invention in a three-dimensional view;

FIG. 5 depicts the receptacle according to FIG. 4 in front view;

FIG. 6 depicts a section along A-A in FIG. 5;

FIG. 7 depicts the connector and receptacle plugged together; and

FIG. 8A-8E depicts some embodiment examples of the arrangement of grooves in connectors and corresponding arrangements of lugs in receptacles.

### DETAILED DESCRIPTION OF THE DRAWINGS

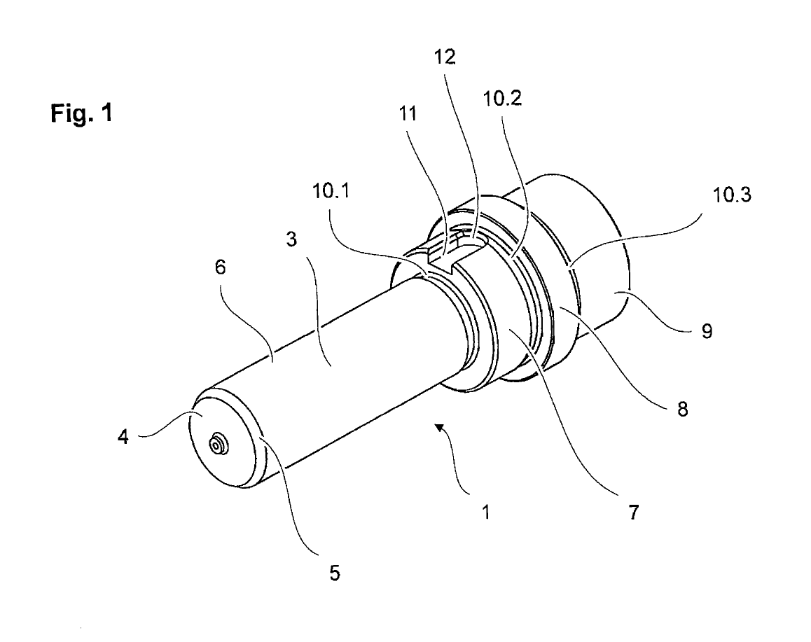

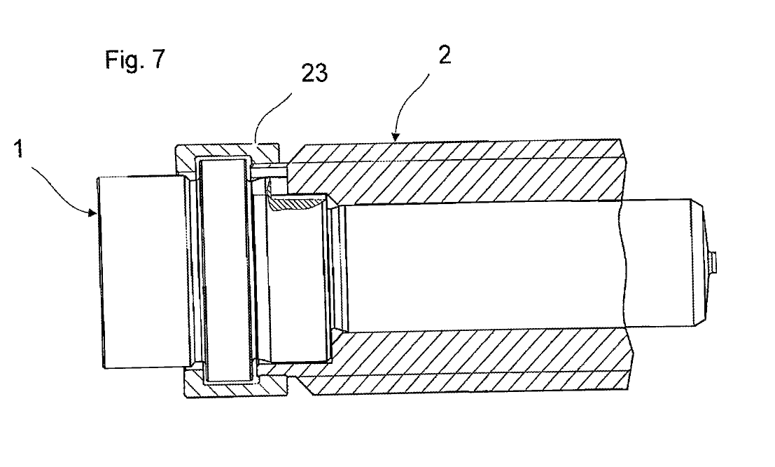

FIGS. 1 to 3 show an embodiment example of a connector 1 according to aspects of the invention, FIGS. 4 to 6 show an embodiment example, corresponding to the embodiment example of the connector 1, of a receptacle 2. In FIG. 7 connector 1 and receptacle 2 are shown plugged together. The connector 1 according to FIGS. 1 to 3 comprises a ferrule 3 which has an end-face 4. Attached to the end-face 4 in the junction to a cylindrical part 6 with an external diameter d1 of the ferrule 3 is a chamfer 5; at the side of the ferrule 3 facing away from the end-face 4, this passes into a cylindrical shoulder 7, the diameter d2 of which is greater than that of the ferrule. A ring 8 with an external diameter d3, which passes into a rear cylindrical body 9 with an external diameter d4, adjoins the cylindrical shoulder 7.

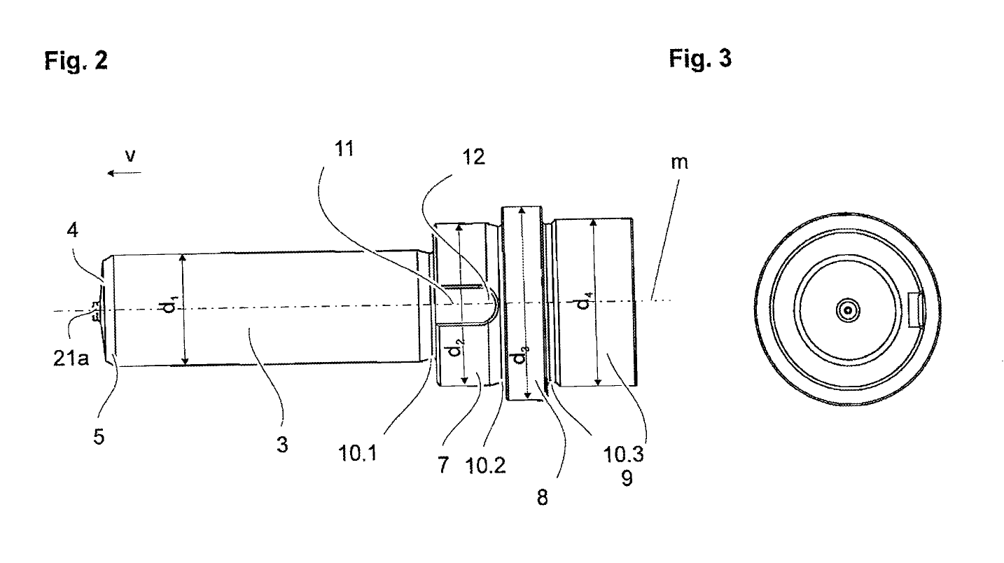

“Forward” refers to the direction towards the end-face 4 (in FIG. 2 the “forward” direction is shown by an arrow v), correspondingly “rearward” refers to the direction seen from the end-face 4 in the direction of the rear cylindrical body 9. Adjoining the rear cylindrical body 9 is an e.g. cylindrical protective cap, not shown here, for an optical fibre 21a. The optical fibre 21a is passed through a bore, which is indicated by a central axis m in FIG. 2, through the ferrule 3, the cylindrical shoulder 7, the ring 8 and the rear cylindrical body 9 and projects forward out of the end-face 4. The junctions between the different diameters d are each provided with a neck, thus the junction between the ferrule 3 and the cylindrical shoulder 7 is provided with a neck 10.1, the junction between the cylindrical shoulder 7 and the ring 8 with a neck 10.2 and the junction between the ring 8 and the rear cylindrical body 9 with a neck 10.3. A groove 11 with a rectangular cross-section is introduced into the cylindrical shoulder 7, wherein the groove 11 has a curve 12 in its rear section. This is necessary for production reasons if the groove is e.g. cut in by an end-milling cutter. The connector 1 is preferably built in one piece and can for example be made as a turned part, wherein the groove 11 is cut in after turning. Instead of a rectangular cross-section, the groove 11 can have a prismatic cross-section, semicircular cross-section, triangular cross-section, etc. Equally, instead of one groove 11, several grooves 11 can be arranged distributed over the periphery.

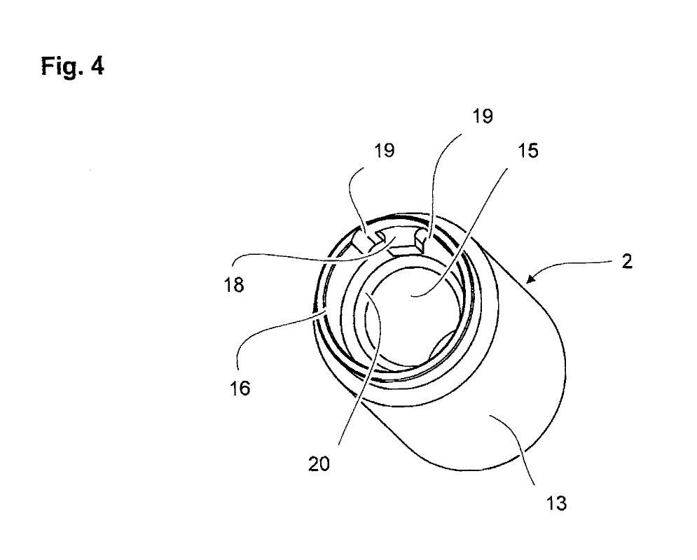

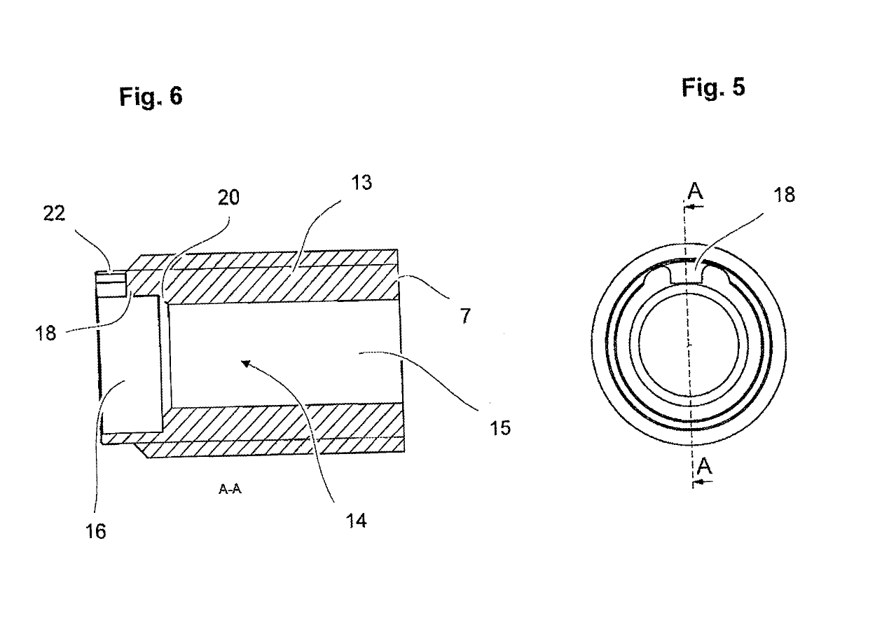

FIGS. 4 to 6 show the receptacle 2 corresponding to the connector 1. As the section in FIG. 6 shows, this comprises a cylindrical base body 13 into which a stepped bore 14 is introduced. Attached to what is its front section when fitted, i.e. when connector 1 and receptacle 2 are plugged together, is an external thread 22 over which a union nut 23 shown in FIG. 7 is screwed to axially secure the connection of connector 1 and receptacle 2. The stepped bore 14 has a bore 15 with a diameter D1 and a bore 16 with a diameter D2 larger than the diameter D1. The bore 15 with the internal diameter D1 serves to receive the ferrule 3, the bore 16 with the internal diameter D2 serves to receive the cylindrical shoulder 7. A housing, not shown here, for the optical fibre 21b adjoins the side of the receptacle 2 facing away from the bore 16 for receiving the cylindrical shoulder 7. Arranged in the bore 16 for receiving the cylindrical shoulder 7 is a lug 18 which, when the connector 1 and the receptacle 2 are plugged together, engages in the groove 11. The lug 18 thus acts as the tongue of a tongue-and-groove connection. The lug 18 together with the groove 11 secure the connector 1 against turning vis-à-vis the receptacle 2. As can be seen in FIG. 5, the lug 18 projects into the bore 16, with the result that the clear width of the bore 16 in the area of the lug 18, which is denoted as radius rN, is smaller than in the remaining section of the bore 16. Notches 19, extending radially outwards, are arranged on both sides of the lug 18. During the manufacture of the lug 18 these make possible the production of a section that can be seen in FIG. 4 with a substantially rectangular cross-section of the lug 18. The bore 16 and the lug 18 and the notches 19 can for example be introduced by means of a milling cutter. The junction between bore 16 and bore 15 has a slope 20. If the connector 1 has several grooves 11, several lugs 18 corresponding to them are arranged in the receptacle 2. The cross-sections of the lugs 18 correspond to the cross-sections of the grooves 11. Thus if a groove 11 has a triangular cross-section for example, the lug 18 corresponding to it also has a triangular cross-section.

The arrangement of grooves 11 and lugs 18 can of course be reversed, with the result that the connectors thus have lugs in each case and the receptacles in each case grooves.

Through a suitable arrangement of grooves 11 and lugs 18 in the connectors 1 and receptacles 2, connector/receptacle combinations can be created in each case in which certain combination[s] can be connected with one another, but not others. Generally, with the embodiment example shown here, in which the connector 1 is provided with grooves 11 and the receptacle 2 with lugs 18, it is possible to introduce a connector according to aspects of the invention into a standard FSMA receptacle.

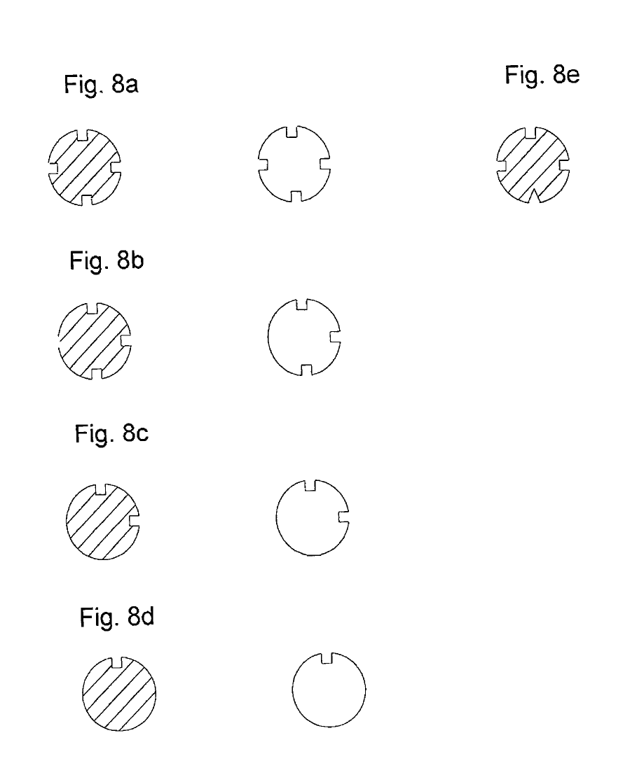

FIGS. 8a to 8d show some embodiment examples of the arrangement of grooves 11 in connectors 1a to 1d and corresponding arrangements of lugs 18 in receptacles 2a to 2d. Shown in each case is a schematic top view of the cylindrical shoulder 7 of the connector 1, with the result that the grooves 11 can be seen, and a top view of the stepped bore 14, with the result that the lugs 18 can be seen. Shown on the left in FIG. 8a is an embodiment example of a connector 1a in which four grooves 11 are each arranged distributed offset by 90° over the periphery, and corresponding to this on the right is shown a receptacle 2a which has four lugs 18 distributed over the periphery. Shown on the left in FIG. 8b is a connector 1b which has three grooves 11, i.e. compared with the connector of FIG. 1a a groove has thus been omitted, while shown on the right is a receptacle 2b, corresponding to the connector 1b, which has three lugs 18 each offset by 90°. Shown on the left in FIG. 8c is a connector which has two grooves 11 which are arranged over the periphery offset by 90°, and shown on the right is a receptacle 2c which has two lugs 18 arranged offset by 90°, and thus corresponds to the connector 1c. In FIG. 8d a connector 1d according to the embodiment examples of FIGS. 1 to 7 is shown and a receptacle 2d corresponding thereto.

FIG. 8e shows a connector 1e, similar to the connector 1a, but here a groove is provided with a triangular cross-section instead of a rectangular cross-section. The connector 1a can be introduced into the receptacle 2a, but equally it is also possible to introduce the connector 1a into the receptacles 2b, 2c or 2d. The connector 1b can be introduced into the receptacles 2b, 2c and 2d, but not into the receptacle 2a, as here there is no groove 11 corresponding to one of the lugs 18, with the result that the connection of connector and receptacle is prevented. Accordingly, the connector 1c can be introduced into the receptacles 2c and 2d, but connector 1d only into the receptacle 2d. A connector according to FIG. 8e, in which overall as in embodiment example 1a four grooves are distributed over the periphery, but in which one of the grooves has a triangular cross-section instead of a rectangular one, can for example be introduced into the receptacles 2b, 2c and 2d, but not into the receptacle 2a. The possibilities of plugging together the connectors 1a to 1d and the receptacles 2a to 2d are shown in Table 1.

TABLE 1

Receptacle

| Connector | 2a | 2b | 2c | 2d |
|---|---|---|---|---|
| 1a | X | X | X | X |
| 1b | | X | X | X |
| 1c | | | X | X |
| 1d | | | | X |

An “X” in the table stands in each case for the possibility of connecting connector and receptacle, while a cell left empty means that there is no possibility of connection here. For the connectors 1a to 1d there is thus a hierarchy of connection possibilities, for example the connector 1a could be provided for consumers permitted to be connected to a particularly high-power laser, the connector 1a for consumers permitted to be connected to a particularly low-power laser, and the connectors 1b and is for consumers of power classes lying in between. The connector 1a can thus be connected to receptacles for lasers of every power class in this four-element system. The connector 1d can still be connected only to the receptacle 2d, with the result that here a connection to a laser-light source of too high a power is not possible. This thus provides a hierarchy of connection possibilities which prevent inadmissible connections from the outset.

The contour of the connector 1 corresponds, apart from the groove 7, to the outer contour of an FSMA ferrule holder of type 905. Alternatively, this can also have the outer contour of an FSMA ferrule holder of type 906. The connector 1 can thus be plugged into a standard FSMA receptacle 2 of type FSMA version 905 or 906. Conversely, in order to plug a connector 1 into the receptacle 2 according to FIGS. 4 to 6, a groove 11 is needed in the cylindrical shoulder 7 of the connector 1, as otherwise the lug 18 strikes against the front end-face of the cylindrical shoulder 7 and prevents a further insertion of the connector 1 into the receptacle 2. A connector according to standard FSMA version 905 or 906, i.e. without the groove 11, can consequently not be fully introduced into the receptacle 2.

The ferrule 3 and the bore 15 for receiving the ferrule 3 form a loose fit, the bore 16 for receiving the cylindrical shoulder 7 and the cylindrical shoulder 7 also forming a loose fit.

The internal diameter D1 is thus slightly larger than the external diameter d1, and the internal diameter D2 is likewise slightly larger than the external diameter d1.

### LIST OF REFERENCE NUMBERS

1 Connector
2 Receptacle
3 Ferrule
4 End-face
5 Chamfer
6 Cylindrical part of the ferrule
7 Cylindrical shoulder
8 Ring
9 Rear cylindrical body
10.1, 10.2, 10.3 Neck
11 Groove
12 Curve
13 Base body
14 Stepped bore
15 Bore for receiving the ferrule 3
16 Bore for receiving the cylindrical shoulder 7
17 Side with means for receiving the optical fibre
18 Lug
19 Notch
20 Slope
21 Optical fibre
22 External thread
23 Union nut

1.-10. (canceled)

11. Connection system comprising a connector and a receptacle through each of which an optical fiber is passed,
wherein the connector comprises a ferrule and also a cylindrical shoulder with a larger diameter than the ferrule on a side of the ferrule facing the fiber,
wherein the receptacle comprises a stepped bore for receiving the ferrule and the cylindrical shoulder,
wherein dimensions of the ferrule, the cylindrical shoulder and the stepped bore correspond to a standard field installable sub-miniature assembly (FSMA) connector or FSMA receptacle,
wherein the connector has at least one groove and the receptacle has at least one tongue corresponding to the at least one groove,
wherein the tongue projects into the groove when the connector and receptacle are plugged together, and
wherein the groove is defined on the cylindrical shoulder and the tongue is defined on the stepped bore.

12. Connection system according to claim 11, wherein the groove and the tongue extend in a radial direction.

13. Connection system according to claim 11, wherein the groove has a rectangular cross-section that extends at least over a portion of a length of the connector, and the tongue has a rectangular cross-section that extends at least over a portion of a length of the receptacle.

14. Connection system according to claim 11, wherein an end of the groove facing the fiber is rounded.

15. Connection system according to claim 11, wherein the tongue is formed by a radially extending lug of the receptacle.

16. Connection system according to claim 15, wherein radially extending notches are arranged on both sides of the lug.

17. Connection system according to claim 11, wherein the connector and the receptacle comprise means for releasable axial fixing to each other.

18. Connection system according to claim 17, wherein the means for releasable axial fixing comprise an external thread of the receptacle for screwing with a union nut guided over the connector.

19. Connector with means of coupling electromagnetic radiation into a fiber for transmitting radiation, wherein the connector has a ferrule and a cylindrical shoulder with a larger diameter than the ferrule on a side of the ferrule facing the fiber, wherein the connector has a radially introduced groove.

20. Receptacle with means of coupling electromagnetic radiation into a fiber for transmitting the radiation, wherein the receptacle has a stepped bore for receiving a ferrule and a cylindrical shoulder of a connector, wherein the receptacle has a lug extending radially inwards.
